(19) United States
(12) Patent Application Publication
(10) Pub. No.: US 2007/0252676 A1
(43) Pub. Date: Nov. 1, 2007

(54) Mobile RFID reader system and method

(75) Inventors: Dariusz Madej, Shoreham, NY (US); Miroslav Trajkovic, Centereach, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/413,047

(22) Filed: Apr. 28, 2006

(51) Int. Cl. H04Q 5/22

(52) U.S. Cl. 340/10.3; 340/825.49

(57) ABSTRACT

Methods, systems, and apparatuses for identifying items carried by a mobile structure are described. At a first location of the mobile structure, a first radio frequency identification (RFID) read signal is directed to a load carried by the mobile structure to identify an initial set of RFID tags. At a subsequent location of the mobile structure, a subsequent read signal is directed to the load carried by the mobile structure to identify a subsequent set of RFID tags. The initial set of RFID tags and the subsequent set of RFID tags are compared to determine a set of RFID tags associated with the load.

### BACKGROUND OF THE INVENTION

1. Field of the Invention

The invention relates to radio frequency identification (RFID) technology, and in particular, to tracking RFID tags carried by a mobile structure.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Because the reader “interrogates” RFID tags, and receives signals back from the tags in response to the interrogation, the reader is sometimes termed as “reader interrogator” or simply “interrogator.”

With the maturation of RFID technology, efficient communication between tags and interrogators has become a key enabler in supply chain management, especially in manufacturing, shipping, and retail industries, as well as in building security installations, healthcare facilities, libraries, airports, warehouses, etc.

An RFID system implemented in a warehouse may employ RFID readers located at gates or portals of the warehouse. Each time a stack of products containing RFID tags passes through a portal, the tags are read by a reader. Such a system can be an effective solution to warehouse product management. However, typically, there must be several RFID portal reader installations, which make the system expensive. One less costly alternative is to attach the reader to a forklift, such that the reader scans tags when their items are loaded or unloaded by the forklift. However, in such an implementation, there is an undesirable possibility that other tags in the reading range of the reader, that are not part of the load, may be read.

Thus, what is needed are ways to improve a quality of communications between readers and tags in an RFID communications environment, such as a warehouse environment, to improve tag read rates and to avoid undesired tag reads.

### BRIEF SUMMARY OF THE INVENTION

Methods, systems, and apparatuses for identifying items carried by a mobile structure are described. At a first location of the mobile structure, a first radio frequency identification (RFID) read signal is directed to a load carried by the mobile structure to identify an initial set of RFID tags. At a subsequent location of the mobile structure, a subsequent read signal is directed to the load carried by the mobile structure to identify a subsequent set of RFID tags. The initial set of RFID tags and the subsequent set of RFID tags are compared to determine a set of RFID tags associated with the load.

In a further aspect, a position determining module is configured to determine the initial location of the mobile structure and the subsequent location of the mobile structure. When the mobile structure is determined to be located at the initial and subsequent locations, the first and second read signals can be initiated.

In a still further aspect, a distance determining module is configured to determine an initial distance to a RFID tag of the initial set of tags at the initial location of the mobile structure, and to determine a subsequent distance to the tag at the subsequent location of the mobile structure. The first distance and the second distance are compared to determine whether the RFID tag is associated with the load.

In further aspects, additional read signals may be directed to the load carried by the mobile structure at one or more additional locations, to generate further read sets of tags. The further read sets of tags may be compared with the initial and subsequent sets of tags to determine the set of RFID tags associated with the load.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of an RFID reader.

FIGS. 3 and 4 show views of a forklift mounting a reader that can be used to carry items having associated tags.

FIG. 5 shows a block diagram of a reader, according to an example embodiment of the present invention.

FIG. 6 shows a flowchart for a reader used to monitor tags associated with items carried by a forklift, according to an example embodiment of the present invention.

FIG. 7 shows an example warehouse environment.

FIG. 8 shows an example forklift navigating the warehouse environment of FIG. 7, and mounting a reader for reading tags, according to an example embodiment of the present invention.

FIG. 9 shows a block diagram of an example reader, according to embodiments of the present invention.

FIG. 10 shows a flowchart for monitoring a position of a mobile structure, according to an embodiment of the present invention.

FIG. 11 shows a flowchart for using distance information to determine whether a tag is being carried by a mobile structure, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

Methods, systems, and apparatuses for RFID readers are described herein. In particular, methods, systems, and apparatuses for monitoring tags carried by a mobile structure are described.

According to embodiments, periodic reads of tags carried by a mobile structure are performed as the mobile structure moves within its environment. The results of the periodic reads are compared to determine a set of tags carried by the mobile structure. Embodiments of the present invention aid in overcoming problems with undesired reads of nearby tags that are not carried by the mobile structure, and with intermittent failed reads of tags that are carried by the mobile structure.

The present specification discloses one or more embodiments that incorporate the features of the invention. The disclosed embodiments merely exemplify the invention. The scope of the invention is not limited to the disclosed embodiments. The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

Example RFID System Embodiment

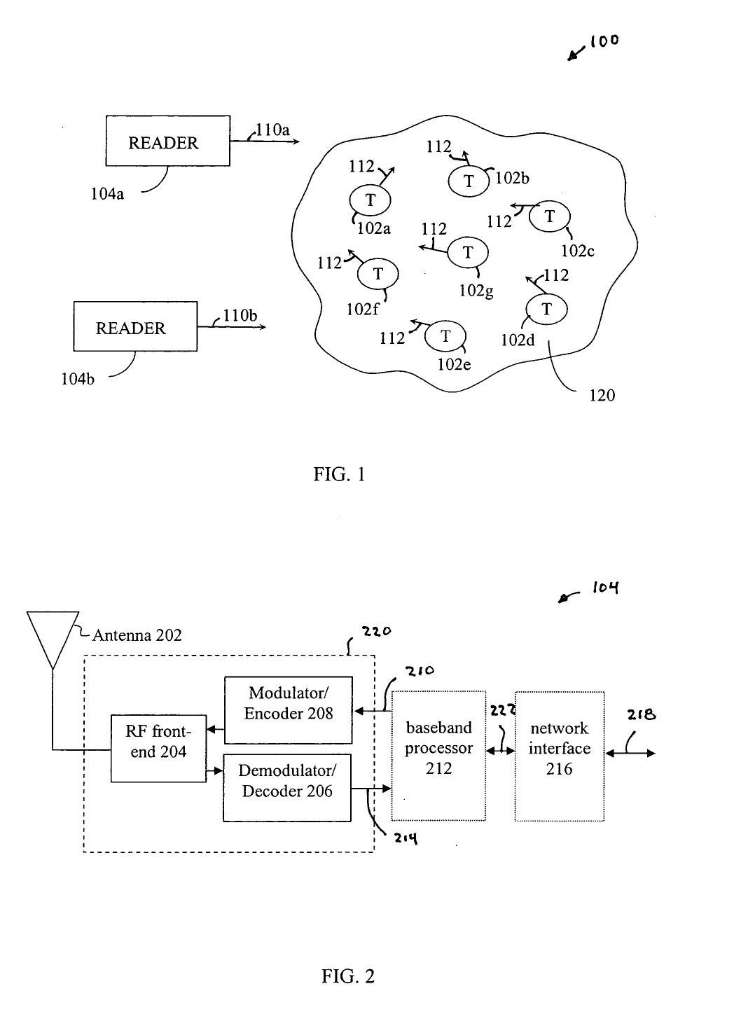

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110a having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as one of FM0 or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a tag response signal through antenna 202 and down-converts (if necessary) the response signal to a frequency range amenable to further signal processing. Furthermore, RF front-end 204 receives a modulated encoded interrogation signal from modulator/encoder 208, up-converts (if necessary) the interrogation signal, and transmits the interrogation signal to antenna 202 to be radiated.

Demodulator/decoder 206 is coupled to an output of RF front-end 204, receiving a modulated tag response signal from RF front-end 204. Demodulator/decoder 206 demodulates the tag response signal. For example, the tag response signal may include backscattered data encoded according to FM0 or Miller encoding formats in an EPC Gen 2 embodiment. Demodulator/decoder 206 outputs decoded data signal 214.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

As further described below, according to embodiments of the present invention, a mobile structure mounts a reader configured to read tags carried by the mobile structure. These embodiments and further embodiments of the present invention are described in further detail below. Such embodiments may be implemented in the environments, readers, and tags described above, and/or in alternative environments and alternative RFID devices, as would be apparent to persons skilled in the relevant art(s).

Example Reader Embodiments and Mobile Structure Environments

Embodiments are described herein for tracking tags carried by a mobile structure. These embodiments can be implemented anywhere that readers and tags are used. For example, embodiments can be implemented in a commercial or industrial environment, such as in a warehouse, a factory, a business, or store, and in a military or other non-commercial environment. Although the mobile structure discussed below is described in terms of a forklift (for illustrative purposes), embodiments of the present invention are applicable to further types of mobile structures, including warehouse box crushers, conveyor belts, cars, trucks, etc.

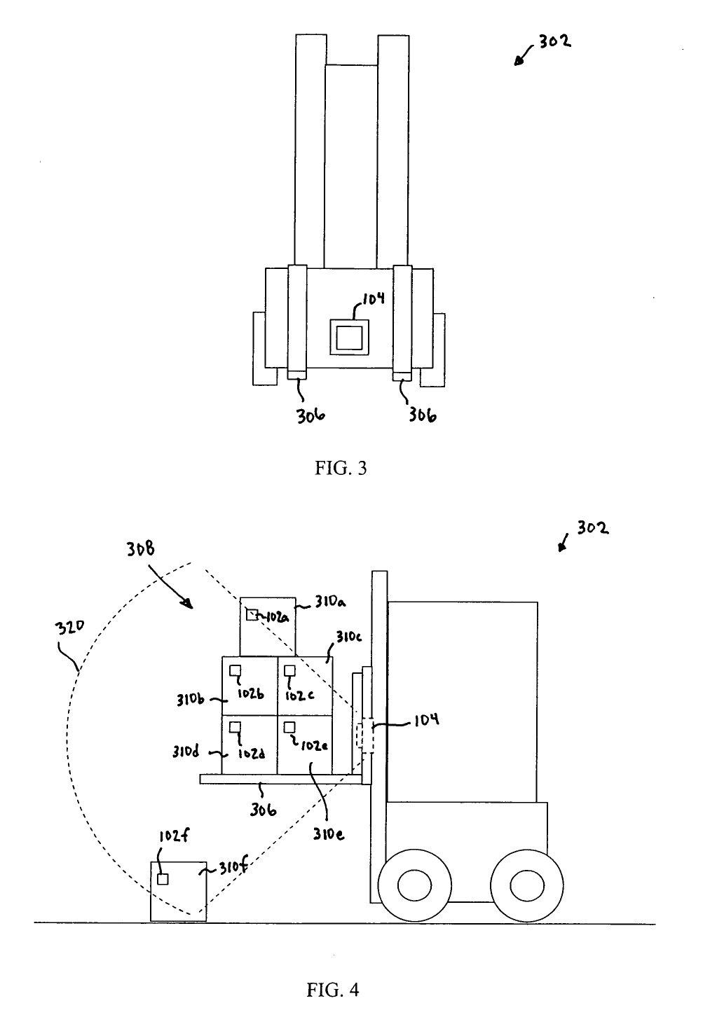

In an operational environment for a reader, the reader may be disposed on a mobile structure such as a forklift. For example, FIGS. 3 and 4 show views of a forklift 302 that mounts a reader 104. FIG. 3 shows a front view of forklift 302, with forks 306 of forklift 302 at a near bottom position. FIG. 4 shows a side view of forklift 302, with forks 306 raised to a middle position and supporting a load 308 of objects 310a-310e. As shown in FIG. 4, each of objects 310a-310e has a respective tag 102a-102e attached thereto.

As shown in FIGS. 3 and 4, reader 104 can be mounted in a location between forks 306 of forklift 302 (e.g., in the “load back rest” area), to be advantageously close to objects 310a-310e, for reading of tags 102a-102e associated with objects 310a-310e. However, reader 104 can alternatively be mounted at other locations of forklift 302. Reader 104 is intended to read tags 102 of objects 310 carried by forklift 302 in load 308. However, in practice, it is difficult to limit reads by reader 104 to only tags 102 associated with load 308.

For example, FIG. 4 shows a cross-sectional view of a read area 320 within an effective read range of reader 104 in front of reader 104. Read area 320 is shown in FIG. 4 as a cone-shaped portion of a sphere (similar in shape to a wide ice cream cone), originating from an antenna of reader 104, but can have other shapes. As shown in FIG. 4, tags 102b-102e of objects 310b-310e in load 308 are within read area 320, and thus should be read by reader 104. However, tag 102a of object 310a is at an edge of read area 320, and thus may or not be read by reader 104 during any particular read cycle. Furthermore, FIG. 4 shows an object 310f that is not part of load 308 having a tag 102f within read area 320. Because tag 102f is within read area 320, object 310f may be erroneously included in load 308 by reader 104.

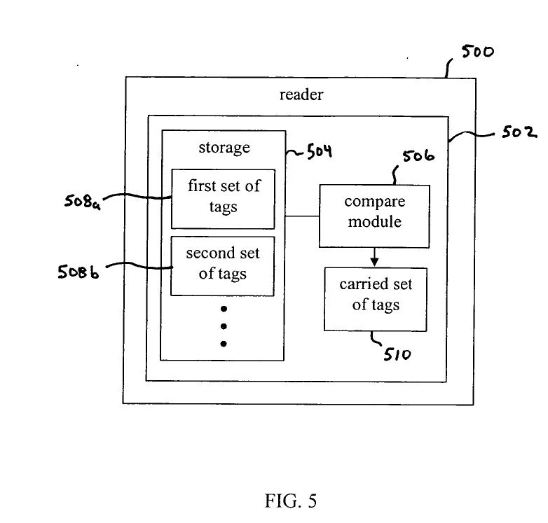

Embodiments of the present invention enable the accurate tracking of tags associated with a load carried by a mobile structure. For example, FIG. 5 shows a reader 500, according to an embodiment of the present invention. In an embodiment, reader 500 is mounted to a mobile structure, such as forklift 302 of FIG. 3. Furthermore, reader 500 may configured similarly to reader 104, such as shown in FIG. 2.

As shown in FIG. 5, a baseband processor 502 of reader 500 includes a storage 504 and a compare module 506. Reader 500 directs read signals to a load carried by the mobile structure, as the mobile structure moves within its environment. Each iteration of read signals results in a set of tags being determined to be present, when the mobile structure is at a particular location in its environment. A particular set of tags can include any number of zero or more tags determined to be present. These sets of tags are stored in storage 504. For example, FIG. 5 shows a first set of tags 508a and a second set of tags 508b stored in storage 504. First set of tags 508a is a set of tags determined to be present when a read of tags is performed at a first location for the mobile structure. Second set of tags 508b is a set of tags determined to be present when a read of tags is performed at a second location for the mobile structure. Further sets of tags 508 may be stored in storage 504 if further read iterations are performed by reader 500. Compare module 506 compares the various sets of tags 508 stored in storage 504 to determine a carried set of tags 510 (i.e., tags associated with objects carried by the mobile structure).

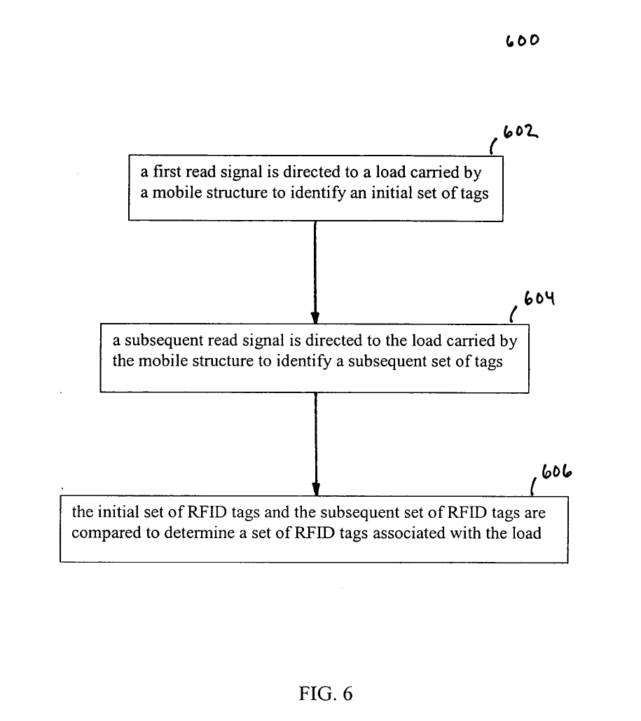

FIG. 6 shows a flowchart 600 providing example steps for determining tags carried by a mobile structure, such as may be performed by a reader system including a reader similar to reader 500 and/or alternative or additional readers. Other structural and operational embodiments will be apparent to persons skilled in the relevant art(s) based on the following discussion.

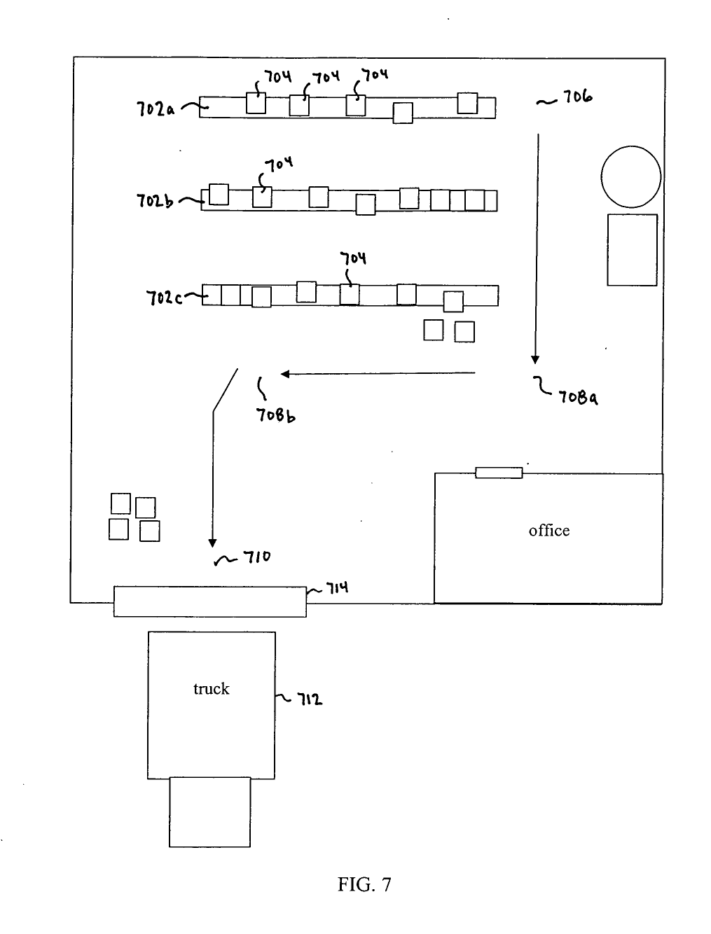

Flowchart 600 is described with respect to an example warehouse environment 700 shown in FIG. 7, for illustrative purposes. As shown in FIG. 7, warehouse environment 700 includes a plurality of shelves 702a-702c. Shelves 702a-702c have various objects 704 placed on them. Objects 704 have tags (not shown in FIG. 7) associated with them (e.g., attached). Objects 704 can be any type of items/objects that may be stored in a warehouse, and are shown as boxes in FIG. 7 for illustrative purposes. During normal operation in warehouse environment 700, some of objects 704 are moved from shelves 702a-702c onto a mobile structure, such as a forklift, at an initial location 706. The mobile structure transports the loaded objects 704 to a subsequent location 710, optionally passing through one or more intermediate locations 708 (shown, for example, as first and second intermediate locations 708a and 708b in FIG. 7) on the way. At subsequent location 710, objects 704 are moved from the mobile structure, such as onto a truck 712 through docking bay door 714, to be transported to a further location.

Note that locations 706, 708, and 710 can be any suitable locations in a warehouse (or other) environment. In an embodiment, a distance between locations (such as location 706, 708, 710) should be sufficient to avoid double reading of stationary elements. For example, a distance between locations 706 and 708 should be such that objects in location 706 are not readable from location 708. For example, a distance between any two locations can be at least two times the maximum reading range of a reader. For example, suitable locations include doorways, corners, randomly selected locations in open areas, etc. Furthermore, the locations can be equally or non-equally spaced from each other.

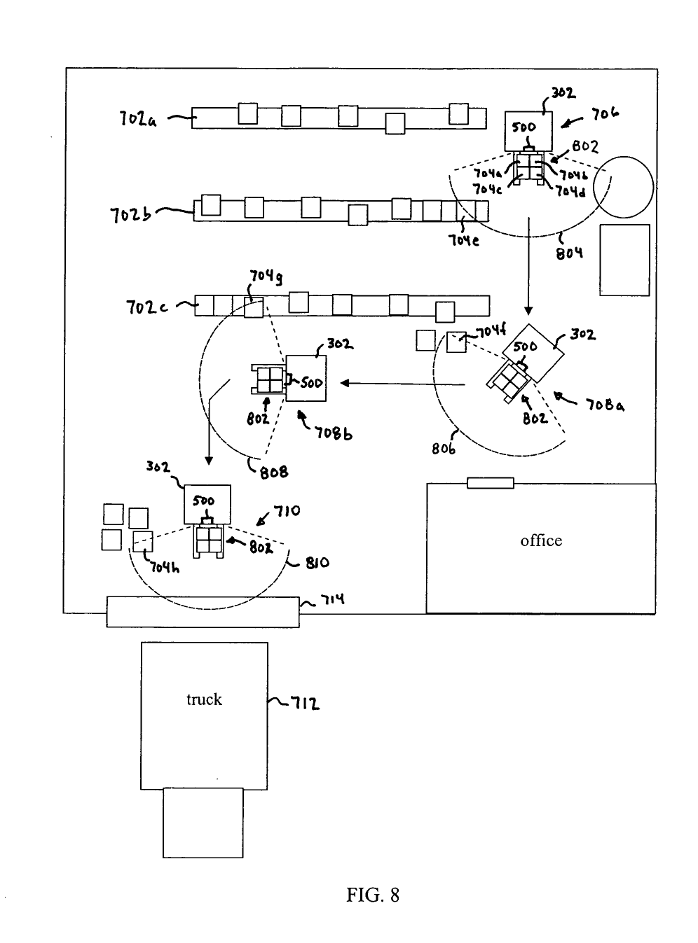

Flowchart 600 begins with step 602. In step 602, a first read signal is directed to a load carried by a mobile structure to identify an initial set of tags. For example, FIG. 8 shows warehouse environment 700 with forklift 302 having a load 802 of objects 704a-704d loaded thereon at initial location 706. A first read signal 804 is directed to load 802 from reader 500 mounted on forklift 302 at location 706. First read signal 804 reads tags of each of objects 704a-704d of load 802. However, as shown in FIG. 8, object 704e, which is not a part of load 802, is within range of read signal 804. Thus, although not a part of load 802, a tag of object 704e is also read by reader 500. The tags of objects 704 read at location 706 by reader 500 are stored in storage 504 as a first set of tags (such as first set of tags 508a shown in FIG. 5). Thus, the first set of tags may list the following information:

Identification number of a tag associated with object 704a

Identification number of a tag associated with object 704b

Identification number of a tag associated with object 704c

Identification number of a tag associated with object 704d

Identification number of a tag associated with object 704e

Because the tag associated with object 704e was read at location 706, object 704e is erroneously included in the first set of tags.

In step 604, a subsequent read signal is directed to the load carried by the mobile structure to identify a subsequent set of tags. For example, forklift 302 travels from location to location along a path indicated by arrows in FIG. 8. At location 710, a subsequent read signal 810 is directed to load 802 from reader 500 mounted on forklift 302. Subsequent read signal 810 reads tags of each of objects 704a-704d of load 802 at location 710. However, as shown in FIG. 8, object 704h is within range of read signal 810. Thus, although not a part of load 802, a tag of object 704h is also read by reader 500. The tags of objects 704 read at location 710 by reader 500 are stored in storage 504 as a second set of tags (e.g., second set of tags 508b shown in FIG. 5). Thus, the second set of tags may list the following information:

Identification number of a tag associated with object 704a

Identification number of a tag associated with object 704b

Identification number of a tag associated with object 704c

Identification number of a tag associated with object 704d

Identification number of a tag associated with object 704h

Because the tag associated with object 704h was read at location 710, object 704h is erroneously included in the second set of tags.

In step 606, the initial set of RFID tags and the subsequent set of RFID tags are compared to determine a set of RFID tags associated with the load. For example, in the current example, compare module 506 of FIG. 5 compares the first set of tags and the second set of tags. In an embodiment, compare module 506 forms the set of RFID tags associated with the load (e.g., carried set of tags 510 shown in FIG. 5) to be those tags that are common to both of the first set of tags and the second set of RFID tags. In the current example, the carried set of tags may list the following information, which is common to both sets of tags:

Identification number of a tag associated with object 704a

Identification number of a tag associated with object 704b

Identification number of a tag associated with object 704c

Identification number of a tag associated with object 704d

Because objects 704e and 704h were not read at both of locations 706 and 710, they are not included in carried set of tags 510. Thus, carried set of tags 510 correctly lists the set of tags carried by forklift 302 (tags of objects 704a-704d). Objects 704e and 704h were not carried by forklift 302, and thus their associated tags were not read at both of locations 706 and 710. Thus, these objects were correctly excluded from carried set of tags 510. Objects 704a-704d can then be loaded into truck 712 (and an additional read can be performed, if desired).

Note that in the current embodiment, reader 500 is mounted to forklift 302, and performs the reads at both of locations 706 and 710. Alternatively, in an embodiment, one or both of the reads at locations 706 and 710 may be performed by stationary readers located within a read communication range (within a communication range of tags) of locations 706 and/or 710. The results of the reads by the stationary readers can then be compared to determine the objects carried by forklift 302.

Note that in embodiments, one or more additional reads of tags may be performed at intermediate locations for the mobile structure. For example, at intermediate location 708a, a first intermediate read signal 806 is directed to load 802 from reader 500 mounted on forklift 302. First intermediate read signal 806 reads tags of each of objects 704a-704d of load 802 at location 708a. However, as shown in FIG. 8, object 704f is within range of read signal 806. Thus, although not a part of load 802, a tag of object 704f is also read by reader 500. The tags of objects 704 read at location 708a by reader 500 are stored in storage 504 as a first intermediate set of tags (not shown in FIG. 5). Thus, the first intermediate set of tags may list the following information:

Identification number of a tag associated with object 704a

Identification number of a tag associated with object 704b

Identification number of a tag associated with object 704c

Identification number of a tag associated with object 704d

Identification number of a tag associated with object 704f

Because the tag associated with object 704f was read at location 708a, object 704f is erroneously included in the first intermediate set of tags.

At a second intermediate location 708b, a second intermediate read signal 808 is directed to load 802 from reader 500 mounted on forklift 302. Second intermediate read signal 808 reads tags of each of objects 704a-704d of load 802 at location 708b. However, as shown in FIG. 8, object 704g is within range of read signal 808. Thus, although not a part of load 802, a tag of object 704g is also read by reader 500. The tags of objects 704 read at location 708b by reader 500 are stored in storage 504 as a second intermediate set of tags (not shown in FIG. 5). Thus, the second intermediate set of tags may list the following information:

Identification number of a tag associated with object 704a

Identification number of a tag associated with object 704b

Identification number of a tag associated with object 704c

Identification number of a tag associated with object 704d

Identification number of a tag associated with object 704g

Because the tag associated with object 704g was read at location 708g, object 704g is erroneously included in the second intermediate set of tags.

In such an embodiment having one or more intermediate set of tags that are read, compare module 506 may compare the initial set of RFID tags (e.g., first set of tags 508a), the intermediate set of RFID tags (e.g., the first and second sets of intermediate tags read at locations 708a and 708b), and the subsequent set of RFID tags (e.g., second set of tags 508b) to determine a set of RFID tags associated with the load. In the current example, if the first set of tags, the first and second sets of intermediate tags, and the subsequent set of tags are compared, the carried set of tags again may list the following information for tags common to all sets:

Identification number of a tag associated with object 704a

Identification number of a tag associated with object 704b

Identification number of a tag associated with object 704c

Identification number of a tag associated with object 704d

Tags of objects 704e-704h are not included in the carried set of tags because they were not common to all read sets.

In the embodiment described above, a tag must be common to each read set of tags to be considered carried by the mobile structure. In another embodiment, although a tag may be listed in less than all read sets, the tag still may be considered to be carried by the mobile structure. For instance, in the example of FIG. 8, at location 708a, the tag of object 704b may not be read by reader 500 due to reflections/RF nulls in the environment, or for other reasons. Thus, the tag of object 704b may not show up in all read sets of tags, being missing from the first intermediate read set of tags at location 708a. However, in an embodiment, compare module 506 may be configured to consider a tag read in 3 out of 4 sets (or other proportion) to be carried by the mobile structure. Thus, in such an embodiment, object 704b would be considered present in carried set of tags 510, even if its associated tag was not read at location 708a, but was read at locations 706, 708b, and 710.

This threshold value for a number of sets in which a tag may fail to be read, and still be considered to be carried by a mobile structure, can be determined for a particular application. This threshold value can be 1 (as in the above example), 2, 3, or even higher number, in part depending on the number of locations at which sets of tags are read.

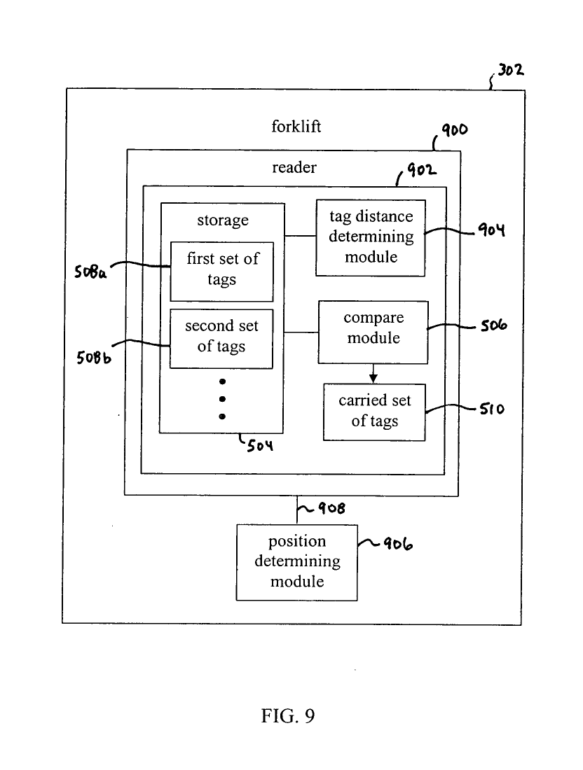

FIG. 9 shows a example reader 900, according to another embodiment of the present invention. As shown in FIG. 9, a baseband processor 902 of reader 900 may include a tag distance determining module 904. Furthermore, as shown in FIG. 9, forklift 302 (or other mobile structure) may include a position determining module 906 that is coupled to reader 900.

Distance determining module 904 can use any suitable distance determining mechanism or process to determine distances to tags. For example, distance estimation may be based on a phase shift in read signals transmitted by reader 900. In an embodiment, precise distance information is not required, merely an indication of a substantial change is distance is desired.

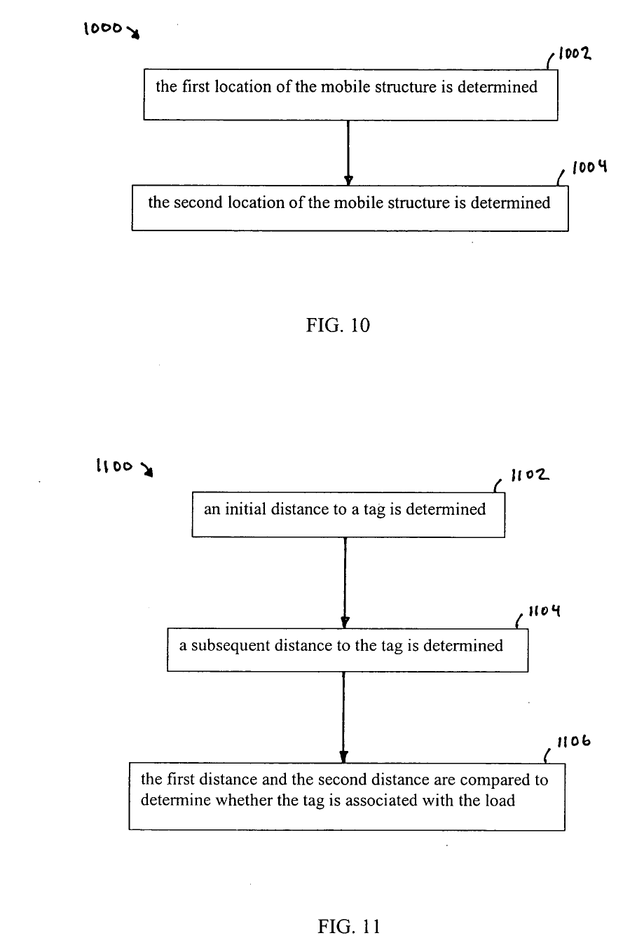

In an embodiment, position determining module 906 may be present on the mobile structure. For example, position determining device 906 may determine a position of the mobile structure as it moves through its environment. For instance, FIG. 10 shows a flowchart 1000 providing steps for using position determining device 906, according to an example embodiment.

Flowchart 1000 begins with step 1002. In step 1002, a first location of the mobile structure is determined. For example, the first location may be initial location 706 (or other location) shown in FIG. 8. When position determining device 906 determines that forklift 302 is at initial location 706, position determining device 906 may provide a signal over communication link 908 to reader 900 to initiate a read of tags of load 802 (e.g., according to step 602 of flowchart 600) to generate an initial set of tags.

In step 1004, a second location of the mobile structure is determined. For example, the second location may be subsequent location 710 (or other location) shown in FIG. 8. When position determining device 906 determines that forklift 302 is at subsequent location 710, position determining device 906 may provide a signal over communication link 908 to reader 900 to initiate a read of tags of load 802 (e.g, according to step 604 of flowchart 600) to generate a subsequent set of tags.

In this manner, position determining device 906 can be used to trigger automatic reads of tags at the designated locations for forklift 302 in warehouse environment 700. Position determining device 906 can use any type of suitable position determiner, including a GPS (global positioning system) device, image recognition, a detector for magnetic patterns located in the environment, optical or mechanical switches in the environment, placement of stationary RF tags as location identifiers, etc. Position determining device 906 can be positioned anywhere on forklift 302, including being integrated in reader 900 or mounted directly to forklift 302. Alternatively, a position determining device 906 is not present, and a user of forklift 302 manually initiates reads of tags, or reads of tags at the various locations are otherwise initiated.

In an embodiment, distance determining module 904 is present in baseband processor 902, or other location. Distance determining module 904 may be implemented in hardware, software, firmware, or any combination thereof. Distance determining module 904 is configured to determine distances to tags, to aid in determining whether a tag should be included in carried set of tags 510.

For example, FIG. 11 shows a flowchart 1100 providing example steps for using distance determining module 904, according to an example embodiment.

Flowchart 1100 begins with step 1102. In step 1102, an initial distance to a tag of the initial set of tags is determined. For example, step 1102 can be performed at initial location 706 (or other location). For instance, distance determining module 904 can determine an initial distance to each of the tags of items 704a-704e. The distances for each tag can be stored in storage 504.

In step 1104, a subsequent distance to the tag is determined. For example, step 1104 can be performed at subsequent location 710 (or other location). Distance determining module 904 can determine a subsequent distance to each of the tags of items 704a-704e. The subsequent distances for each tag can be stored in storage 504.

In step 1106, the first distance and the second distance are compared to determine whether the tag is associated with the load. In an embodiment, compare module 506 performs step 1106, although step 1106 can alternatively be performed elsewhere. For tags of items 704a-704d, the corresponding initial and subsequent distances will be roughly equal, because each of items 704a-704d are carried by forklift 312. For a tag of item 704e, the initial distance determined at location 706 will be relatively short (from reader 900 to the tag). At location 710, the subsequent distance for the tag of item 704e will be relatively far (far if the tag is successfully read, infinite if no response is received from the tag), as item 704e is far away from subsequent location 710. Thus, the initial and subsequent distances for the tag of item 704e will be substantially different. Item 704e will accordingly be determined to have moved relative to forklift 302, and thus will not be associated with load 802 of forklift 302. Thus, compare module 506 may use this determination to remove the tag of item 704e from carried set of tags 510, even if the tag of item 704e was successfully read at subsequent location 710.

In embodiments, the distance determination may be repeated two or more times along the path of movement of forklift 312, and a variance of the distance between reader 900 and tag is used to determine whether reader 900 is stationary relative to a tag or whether reader 900 is moving. A low variance (e.g., a variance in a range of no difference in distance to a difference of less than a foot or two of distance) is indicative of a tag most likely included in load 802, while a high variance (e.g., a variance of a distance greater than one or more feet) means reader 900 moves relative to tag, and thus the tag is likely outside of load 802. The applicable variance distance criteria may depend on the particular application.

Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system (e.g., a reader) using a removable storage drive, hard drive, or communications interface. The control logic (software), when executed by a processor, causes the processor to perform the functions of the invention as described herein.

According to an example embodiment, a reader may execute computer-readable instructions to read tags, compare read sets of tags, determine distances to tags, and/or perform other functions, as further described elsewhere herein.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for identifying items carried by a mobile structure, comprising:
(a) at a first location of the mobile structure, directing a first read signal to a load carried by a mobile structure to identify an initial set of radio frequency identification (RFID) tags;
(b) at a subsequent location of the mobile structure, directing a subsequent read signal to the load carried by the mobile structure to identify a subsequent set of RFID tags; and
(c) comparing the initial set of RFID tags and the subsequent set of RFID tags to determine a set of RFID tags associated with the load.

2. The method of claim 1, wherein step (a) comprises:
formatting the first RFID read signal according to an EPC Gen 2 communications protocol, a Class 0 communications protocol, or a Class 1 communications protocol.

3. The method of claim 1, wherein step (a) comprises:
generating the first read signal with a RFID reader mounted on the mobile structure; and
wherein step (b) comprises:
generating the subsequent read signal with the RFID reader mounted on the mobile structure.

4. The method of claim 1, wherein step (a) comprises:
generating the first read signal with a first RFID reader mounted within a communication range of the first location; and
wherein step (b) comprises:
generating the subsequent read signal with a second RFID reader mounted within a communication range of the subsequent location.

5. The method of claim 1, wherein step (c) comprises:
forming the set of RFID tags associated with the load to consist of tags common to both of the initial set of RFID tags and the subsequent set of RFID tags.

6. The method of claim 1, wherein step (a) comprises:
reading a RFID tag that is associated with an item not carried by the mobile structure; and
including the RFID tag in the initial set of RFID tags.

7. The method of claim 6, wherein the RFID tag is not read during step (b), wherein step (c) comprises:
forming the set of RFID tags associated with the load to not include the RFID tag.

8. The method of claim 1, wherein a RFID tag associated with an item not carried by the mobile structure is not read during step (a), wherein step (b) comprises:
reading the RFID tag; and
including the RFID tag in the initial set of RFID tags.

9. The method of claim 8, wherein step (c) comprises:
forming the set of RFID tags associated with the load to not include the RFID tag.

10. The method of claim 1, further comprising:
(d) at an intermediate location of the mobile structure, directing an intermediate read signal to the load carried by the mobile structure to identify an intermediate set of RFID tags.

11. The method of claim 10, wherein step (c) comprises:
(1) comparing the initial set of RFID tags, the intermediate set of RFID tags, and the subsequent set of RFID tags to determine a set of RFID tags associated with the load.

12. The method of claim 11, wherein step (1) comprises:
forming the set of RFID tags associated with the load to consist of tags common to the initial set of RFID tags, the intermediate set of RFID tags, and the subsequent set of RFID tags.

13. The method of claim 1, further comprising:
(d) determining the first location of the mobile structure during step (a); and
(e) determining the second location of the mobile structure during step (b).

14. The method of claim 1, further comprising:
(d) at the first location, determining an initial distance to a RFID tag of the initial set of radio frequency identification (RFID) tags; and
(e) at the second location, determining a subsequent distance to the RFID tag;
wherein step (c) comprises:
comparing the first distance to the second distance to determine whether the RFID tag is associated with the load.

15. The method of claim 1, further comprising:
(d) at the first location, determining an initial distance between a RFID reader of the mobile structure and a RFID tag of the initial set of radio frequency identification (RFID) tags; and
(e) at the second location, determining a subsequent distance between the RFID reader of the mobile structure and the RFID tag;
wherein step (c) comprises:
determining a variance between the initial distance and the subsequent distance to determine whether the RFID reader is stationary relative to the RFID tag, wherein if the variance is relatively low the RFID tag is associated with the load, and if the variance is relatively high the RFID tag is not associated with the load.

16. A system for identifying items carried by a mobile structure, comprising:
means for directing a first read signal to a load carried by a mobile structure to identify an initial set of radio frequency identification (RFID) tags;
means for directing a subsequent read signal to the load carried by the mobile structure to identify a subsequent set of RFID tags; and
means for comparing the initial set of RFID tags and the subsequent set of RFID tags to determine a set of RFID tags associated with the load.

17. The system of claim 16, further comprising:
a reader means mounted on the mobile structure, wherein the reader means comprises the means for directing the first read signal and the means for directing the subsequent read signal.

18. The system of claim 16, further comprising:
a first reader means comprising the means for directing the first signal, wherein the first reader means is mounted within a communication range of a first location in an environment for the mobile structure; and
a second reader means comprising the means for directing the subsequent read signal, wherein the second reader means is mounted within a communication range of a second location in an environment for the mobile structure.

19. The system of claim 16, wherein said means for comparing comprises:
means for forming the set of RFID tags associated with the load to consist of tags common to both of the initial set of RFID tags and the subsequent set of RFID tags.

20. A radio frequency identification (RFID) reader system, comprising:
an antenna;
a transceiver coupled to the antenna; and
a baseband processor coupled to the transceiver;
wherein the baseband processor comprises a compare module configured to compare a initial set of tags to a subsequent set of tags to determine a set of tags associated with a load carried by a mobile structure;
wherein the initial set of tags are tags read by the reader at an initial location for the mobile structure, and the second set of tags are tags read by the reader at a subsequent location for the mobile structure.

21. The reader system of claim 20, wherein the antenna and transceiver are located in reader mounted to the mobile structure.

22. The reader system of claim 21, wherein the baseband processor is located in the reader.

23. The reader system of claim 21, wherein the baseband processor is located at a location external to the reader.

24. The reader system of claim 20, wherein the compare module is configured to determine the set of RFID tags associated with the load to consist of tags common to both of the initial set of RFID tags and the subsequent set of RFID tags.

25. The reader system of claim 20, wherein the compare module is configured to compare the initial set of tags, an intermediate set of tags, and the subsequent set of tags to determine a set of tags associated with a load carried by a mobile structure;
wherein the intermediate set of tags are tags read by the reader at an intermediate location for the mobile structure.

26. The reader system of claim 20, further comprising:
a positioning determining module configured to determine the initial location of the mobile structure and the subsequent location of the mobile structure.

27. The reader system of claim 20, further comprising:
a distance determining module configured to determine an initial distance to a RFID tag of the initial set of radio frequency identification (RFID) tags at the initial location of the mobile structure, to determine a subsequent distance to the RFID tag at the subsequent location of the mobile structure;
wherein the compare module is configured to compare the first distance to the second distance to determine whether the RFID tag is associated with the load.
